(19) United States
(12) Patent Application Publication
(10) Pub. No.: US 2014/0366861 A1
(43) Pub. Date: Dec. 18, 2014

(54) STOW AWAY ELECTRIC GRILL

(71) Applicant: John Michael Johnson, Vicksburg, MI (US)

(72) Inventor: John Michael Johnson, Vicksburg, MI (US)

(21) Appl. No.: 13/916,506

(22) Filed: Jun. 12, 2013

(51) Int. Cl. B60N 3/16

(52) U.S. Cl. CPC B60N 3/16
USPC 126/57

(57) ABSTRACT

An electric teppanyaki grill mounted on two rails slideably fastened inside a compartment and connected to a source of electric current wherein the teppanyaki grill can be extended outside of the compartment on the rails to provide a safe and efficient cooking surface. The grill is especially suited for use in recreational vehicles.

### FIELD OF INVENTION

This invention relates to an apparatus for storing and accessing an electric teppanyaki grill.

### DISCUSSION OF PRIOR ART

Cook top electric and natural gas fueled grills have been flush mounted in countertops and tables both for home and commercial use. There are also portable versions for use both indoors and outdoors. A teppanyaki grill employs a metal plate that serves as a grilling surface usually located in the center of a table. The center of the table is hot enough to provide a cooking surface surrounded first by a warming surface and then by a room temperature surface. U.S. Pat. No. 8,020,546 discloses a teppanyaki style grilling surface top on a pedestal configured to provide multiple sitting areas with knee areas in between the pedestal and top periphery. There is also a teppanyaki grill on the market that includes a center surface that temporarily sinks down slightly to provide a concave cooking pit surrounded first by a warming area followed by a dining area that stays cool. The concave surface retains the juices while heated but returns to form a flat surface when the electric heating element below the surface is turned off. This grill has been built into a table top or provided in a smaller portable version that does not have three distinct surfaces but does retain the concave cooking pit when heated.

### SUMMARY OF INVENTION

The present invention provides another version of an electric teppanyaki grill that fits on rails mounted inside a compartment and extends out of the compartment when it is being used for grilling. For safety and convenience considerations it is uniquely appropriate for installation in a compartment located in a recreational vehicle from which the grill can be extended outside the recreational vehicle when in use and returned back into the compartment when stored. This provides a much safer and more convenient grill than the gas or charcoal fired grills found on many recreational vehicles. The teppanyaki grill preferably has a concave heating surface when heated and returns to flat surface when turned off. The heated surface not only retains the juices of food being grilled but also requires no pots and pans for cooking and is easier to clean especially if the surface is stainless steel. This feature of the grill most especially preferred for the present invention is covered in detail by U.S. Pat. No. 5,782,172 which is incorporated herein by reference.

Expressed broadly the present invention is an electric teppanyaki grill mounted on two telescopic rails fastened to a compartment having a door that opens to permit the teppanyaki grill to be slidably extended out of the compartment on the telescopic rails to provide a safe and efficient cooking surface when extended outside the compartment and returned back into the compartment for storage.

In a more preferred version the present invention is an electric teppanyaki grill having a stainless steel surface, the surface having a center section that depresses when heated by a heating device below the stainless steel surface and is surrounded by a warming area, the teppanyaki grill being mounted on two rails fastened to a compartment having a door that opens out on an outside surface of a recreational vehicle wherein the teppanyaki grill can be extended out of the compartment on the rails to provide a safe and efficient cooking surface outside the recreational vehicle and returned back into the compartment for storage.

### DRAWINGS

FIG. 1 depicts a teppanyaki grill extending out of a storage compartment in the side of a recreational vehicle.

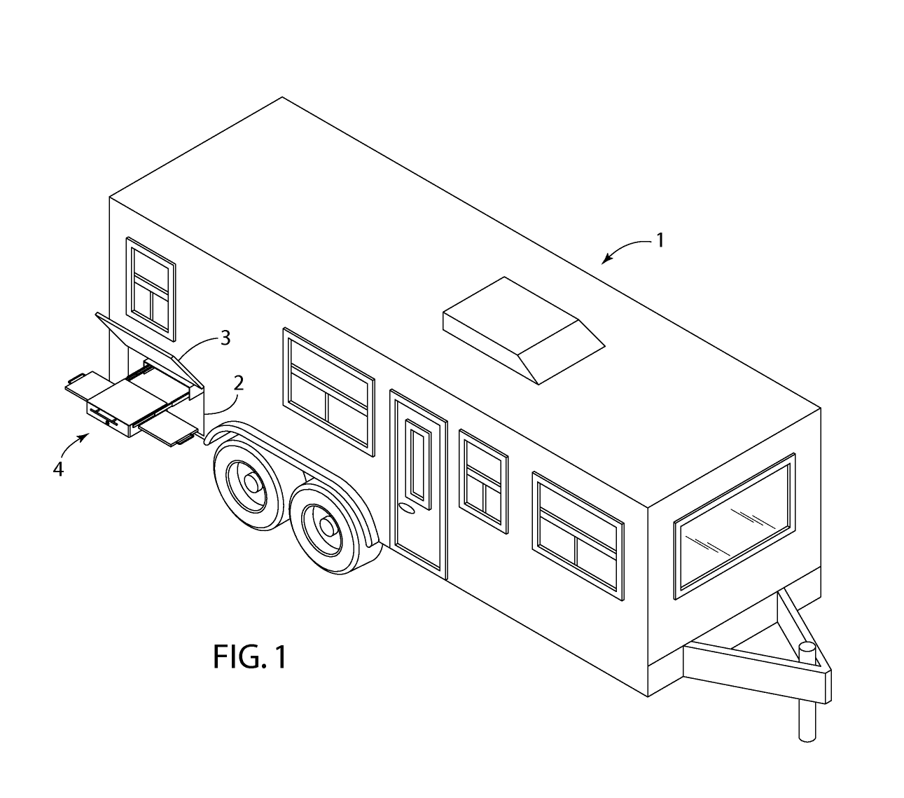

FIG. 2 depicts the fully extended rack containing the teppanyaki grill before installation in the storage compartment.

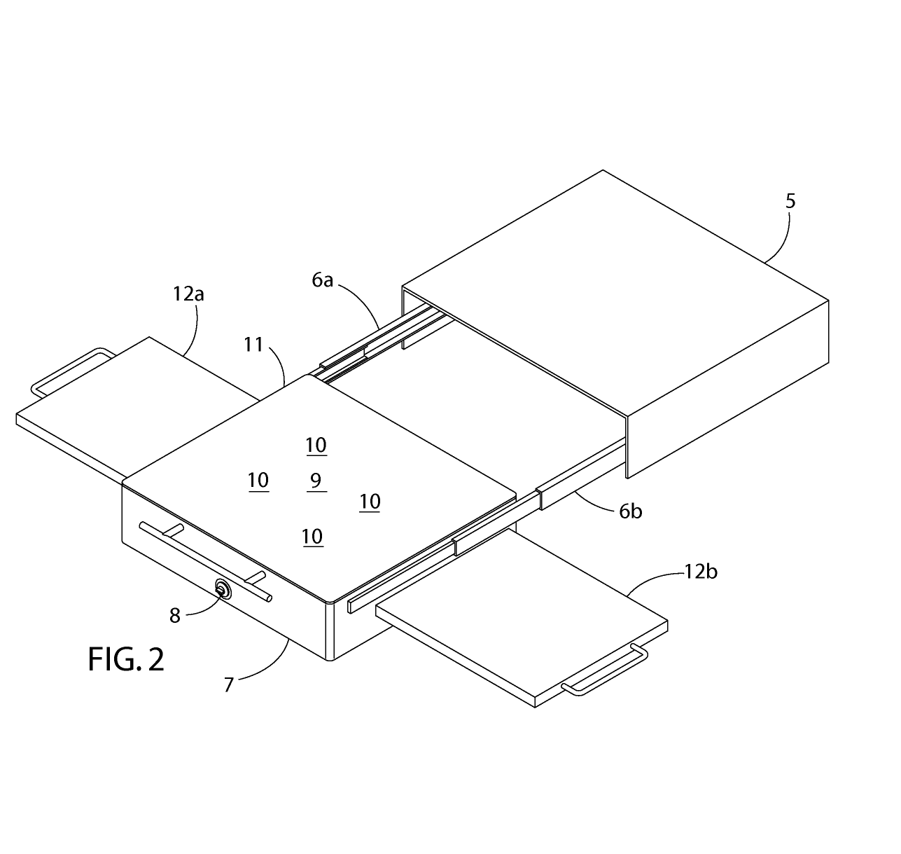

FIG. 3 depicts the bracket that connects the rack to the inside sidewalls of the storage compartment.

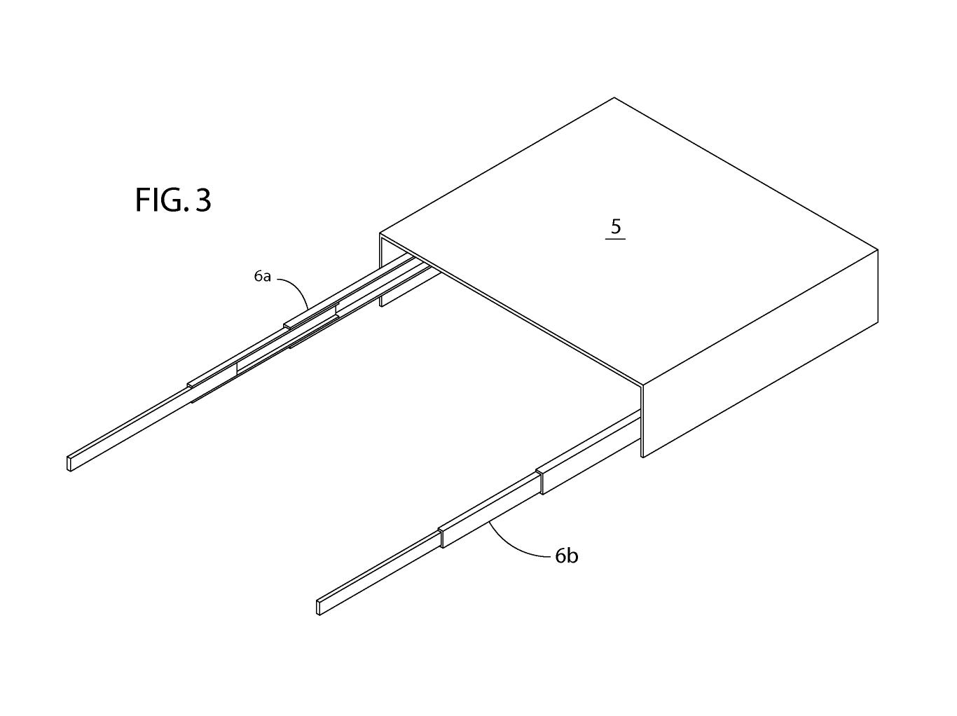

FIG. 4 depicts the locking mechanism that secures the rack while stored in the compartment.

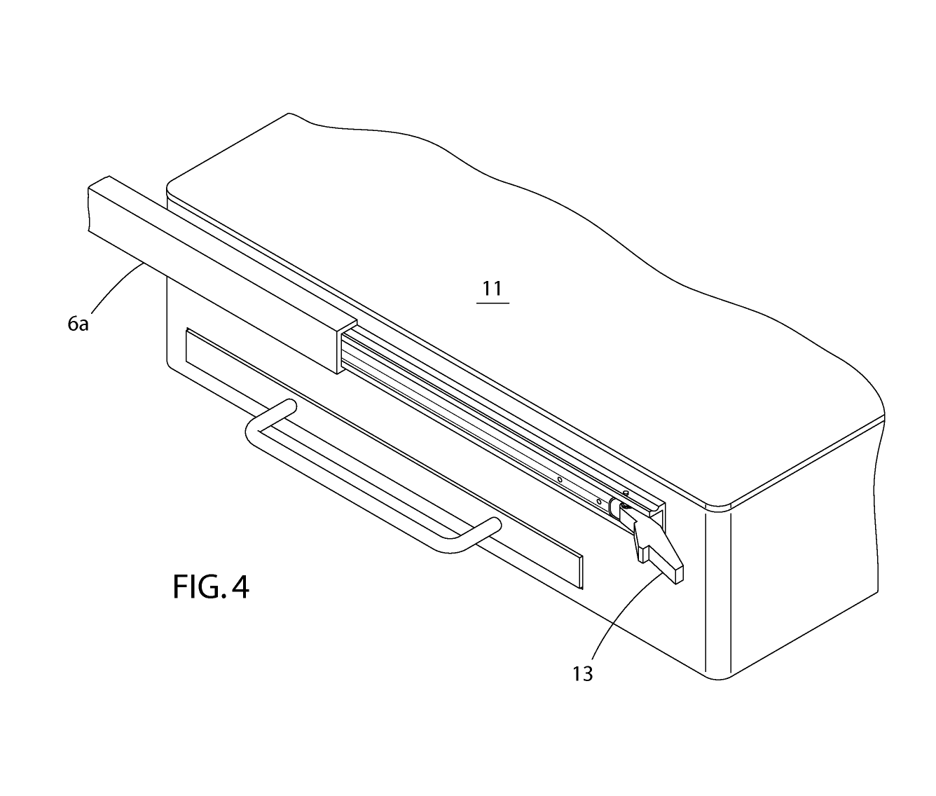

### LIST OF REFERENCE NUMERALS

1. Recreational vehicle

2. Storage compartment

3. Compartment Door

4. Pullout rack

5. Mounting bracket

6a, 6b. Rails

7. Teppanyaki Grill

8. Controls

9. Cooking center

10. Warming area

11. Grill top

12a,12b. Pull out shelves

13. Locking mechanism

### DETAILED DESCRIPTION OF PREFERRED EMBODIMENTS

The preferred embodiment of the teppanyaki grill 7 of the present invention is an integrated slide-out rack 4 for use on most recreational vehicles (RV) 1. It is stored in a storage compartment 2 behind a door 3 and can be easily and conveniently pulled out like a drawer on high-quality stainless steel roller guides, more generally referred to as telescopic rails 6a,6b. The bracket 7 that attaches the rack 4 inside the compartment has the general shape of an inverted U having a flattened bottom wide enough and sides tall enough to enclose the top and sides of the grill 7 with the rails fastened between the bracket 5 and the sides of the grill 7. The preferred external slide-out cooker is an electro Teppanyaki Gourmet Built-in Cook Top Grill sold by Cook-N-Dine available online at www.cook-n-dine-usa.com. The grill cook top 11 is made from commercial, CERTIFIED food grade German stainless steel, best alloy, type 304, ⅛″ to 5/32″ thick (8-10 gauge) with an elegant but robust silk-brushed finish which is easy to clean. The RV Teppanyaki Grill 7 features a warming area 10 of about 3 inches surrounding the hot cooking center 9, similar to the “wok” cooking principle. Only a 2-3 minute warm-up time is required. No cooking pots or pans are required saving a lot of cleaning time compared to gas or coal grills. Additional shelf space is provided by the two shelves 12a,12b that function as worktops that slide out on both sides of the pull-out rack. Three windshields can be fastened on the sides and back of the pull out rack 4. The Cook-N-Dine Stove 7 and Pull-out Rack 4 are made and assembled in Germany in Food Grade Stainless Steel exclusively for the RV Outfitters Company in Michigan, USA.

The storage compartment can also be located in a stationary building instead of an RV. The roller guides are not critical and can be any telescopic rails that slide or pass one within the other to facilitate movement of the rack in and out of the compartment. The cooking surface can also be a plate with a center that is not depressed when heated although a concave cooking surface when heated is especially preferred. Likewise a fine stainless steel cooking surface and shelves are also preferred but not necessary features of the present invention. The grill can either be plugged or hard wired into a source of electric current, although a plug provides for a more flexibly located unit.

The foregoing preferred embodiment is fast, convenient to use, and safe because it is flameless and requires no toxic chemicals. No messy prep work or carrying of pots and pans are required. Only 2-3 minute warm up time is required. No nasty smells occur during use or cleaning. Only a little water, a spatula and paper towels are required while the cooking surface is still warm for clean up and polishing of the cooking surface. There are no pots and pans to clean up. No handling of fuel, gas or charcoal is required, only clean electric energy provided by the 120 Volt AC provided by the RV where the unit can be plugged in. The foregoing advantages mostly apply to the broadest concept of the present invention.

The foregoing provides a general description and a most especially preferred version of the present invention. It should be understood that various substitutions, variations and modifications can be made by those skilled in the art without departing from the spirit and scope of the invention as further delineated in the following claims.

What is claimed is:

1. An electric teppanyaki grill mounted on two telescopic rails fastened to a compartment having a door that opens to permit the teppanyaki grill to be slidably extended out of the compartment on the telescopic rails to provide a safe and efficient cooking surface outside the compartment and returned back into the compartment for storage.

2. The electric teppanyaki grill of claim 1 further comprising a recreational vehicle in which the compartment is located.

3. The electric teppanyaki grill of claim 1 wherein the cooking surface is a fine steel plate that has a center surface that is flat when cold and concave when heated, the center surface being surrounded by a warming area.

4. The electric teppanyaki grill of claim 2 further comprising an electric heating device centrally located under the fine steel plate and plugged or hard wired into the recreational vehicle.

5. The electric teppanyaki grill of claim 1 further comprising the teppanyaki grill has a front, a right and a left side with a shelf that slides out of the right and left sides after the teppanyaki grill is extended out of the compartment using a handle affixed to the front side.

6. The electric teppanyaki grill of claim 1 further comprising a plug for connecting to a source of electric current.

7. The electric teppanyaki grill of claim 1 further comprising a locking mechanism on a rail to secure the teppanyaki grill when stored inside the compartment.

8. An electric teppanyaki grill having a stainless steel surface, the surface having a center section that depresses when heated by a heating device below the stainless steel surface and is surrounded by a warming area,
a. wherein the teppanyaki grill is mounted on two stainless steel roller guides fastened to a bracket fully and fixedly enclosed inside a compartment having a door that opens out on an outside surface of a recreational vehicle and
b. further wherein the teppanyaki grill can be extended in and out of the compartment on the roller guides to provide a safe and efficient cooking surface when extended outside the recreational vehicle.

9. The electric teppanyaki grill of claim 7 further comprising the teppanyaki grill has a front, a right and a left side with shelves that slide out of the right and left sides after the teppanyaki grill is extended out of the compartment using a handle affixed to the front side.

10. The electric teppanyaki grill of claim 7 further comprising a plug for connecting to electric current supplied by the recreational vehicle.

11. The electric teppanyaki grill of claim 7 further comprising a locking mechanism on a rail to secure the

12. The electric teppanyake grill of claim 7 wherein the bracket has the general shape of an inverted U having a flattened bottom wide enough and vertical sides tall enough to enclose the top and sides of the teppanyaki grill inside the inverted U with the roller guides fastened between the bracket and the teppanyaki grill
